(19) United States
(12) Patent Application Publication
(10) Pub. No.: US 2026/0021665 A1
(43) Pub. Date: Jan. 22, 2026

(54) IMAGE FORMING APPARATUS

(71) Applicant: Toshiba Tec Kabushiki Kaisha, Tokyo (JP)

(72) Inventor: Kazuyuki YOSHIKOSHI, Singapore (SG)

(21) Appl. No.: 19/252,759

(22) Filed: Jun. 27, 2025

(30) Foreign Application Priority Data
Jul. 18, 2024 (JP) 2024-114789

(51) Int. Cl. B41J 2/355; B41J 3/407

(52) U.S. Cl. CPC B41J 2/3553; B41J 3/4075

(57) ABSTRACT

According to an embodiment, an image forming apparatus according to an embodiment determines whether or not it is necessary to check for malfunctions on a basis of a priority setting for each image region in a print image. Further, the image forming apparatus executes a malfunction check using a check circuit on a heating element that has been determined to need to be subjected to a malfunction check.

### CROSS-REFERENCE TO RELATED APPLICATIONS

This application is based upon and claims the benefit of priority from the prior Japanese Patent Application No. 2024-114789, filed on Jul. 18, 2024, the entire contents of which are incorporated herein by reference.

### FIELD

An embodiment to be described here generally relates to an image forming apparatus.

### BACKGROUND

One type of image forming apparatus placed in a workplace is a thermal transfer printer (thermal printer). The thermal printer transfers ink onto a medium by applying heat to an ink ribbon superimposed on the medium. The thermal printer includes a thermal head having a plurality of heating elements (elements) arranged in a printing line.

The thermal printer prints an image onto a medium by controlling the heat generation of each heating element in accordance with image data while conveying an ink ribbon and the medium, which are superimposed on each other, to a print position. Each heating element in the thermal head is connected to a drive circuit and the like, and generates heat in accordance with the amount of heat supplied from the circuit.

The thermal printer sometimes checks for disconnection of each heating element as a malfunction to confirm that the individual heating element is in a condition to print normally. The disconnection check of each heating element in the thermal head cannot be executed while any of a group of heating elements arranged in the printing line is printing. The existing thermal printer has the problem that it takes time to perform the printing operation and the disconnection check because the disconnection check of each heating element is executed while the printing operation is stopped.

### BRIEF DESCRIPTION OF THE DRAWINGS

FIG. 1 is a block diagram showing a configuration example of a label printer as an image forming apparatus according to an embodiment.

FIG. 2 is a diagram showing an example of a print image printed by the label printer as the image forming apparatus according to the embodiment on a label material as a print medium.

FIG. 3 is a diagram showing an example in which the label printer according to the embodiment prints a print image on a plurality of label materials arranged on label paper.

FIG. 4 is a diagram showing a first configuration example of a heating element group included in a thermal head used in the label printer as the image forming apparatus according to the embodiment.

FIG. 5 is a diagram showing a second configuration example of the heating element group included in the thermal head used in the label printer as the image forming apparatus according to the embodiment.

FIG. 6 is a flowchart describing a printing operation including a disconnection check by the label printer as the image forming apparatus according to the embodiment.

FIG. 7 is a flowchart describing an operation example of the disconnection check in the label printer as the image forming apparatus according to the embodiment.

FIG. 8 is a flowchart describing an operation example of disconnection error processing in the label printer as the image forming apparatus according to the embodiment.

FIG. 9 is a diagram showing an example of a print defect mark printed on the label material in the case where the label printer as the image forming apparatus according to the embodiment has detected disconnection of a heating element.

FIG. 10 is a diagram showing an example of an error notification screen displayed on a display device in the case where the label printer as the image forming apparatus according to the embodiment has detected disconnection of a heating element.

FIG. 11 is a diagram showing an example of a mark additionally printed in the case where the label printer as the image forming apparatus according to the embodiment has detected disconnection of a heating element.

### DETAILED DESCRIPTION

According to an embodiment, an image forming apparatus includes: a conveying motor, a thermal head, a head driving device, a check circuit, and a processor. The conveying motor conveys a print medium to a print position. The thermal head has a plurality of heating elements arranged in a printing line orthogonal to a conveying direction of the print medium at the print position. The head driving device causes each of the heating elements to generate heat in accordance with image data for each printing line of the print image. The check circuit checks for malfunctions for each of the heating elements. The processor executes malfunction check using the check circuit on a heating element that has been determined to need to be subjected to a malfunction check on a basis of a priority setting for each image region in the print image.

A label printer as an image forming apparatus according to an embodiment will be described with reference to the drawings. However, in the drawings used in the following description of the embodiment, the scales of the respective portions are altered as appropriate in some cases. Further, in the drawings used in the following description of the embodiment, some of the configurations are simplified in some cases in order to make the description easier to understand. In the drawings, the same reference symbols will denote the same or similar portions.

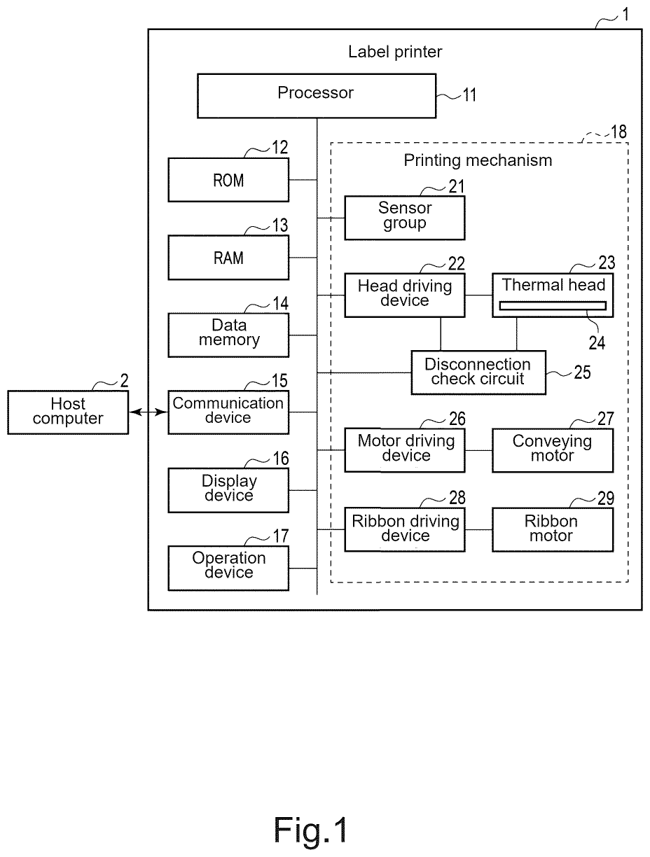

First, a configuration of a label printer 1 as the image forming apparatus according to the embodiment will be described. FIG. 1 is a block diagram showing a configuration example of the label printer 1 as the image forming apparatus according to the embodiment. The label printer 1 is placed in a workplace. In the configuration example shown in FIG. 1, the label printer 1 includes a processor 11, a read only memory (ROM) 12, a random access memory (RAM) 13, a data memory 14, a communication device 15, a display device 16, an operation device 17, a printing mechanism 18, and the like. Further, the printing mechanism 18 includes a sensor group 21, a head driving device 22, a thermal head 23, a disconnection check circuit 25, a motor driving device 26, a conveying motor 27, a ribbon driving device 28, a ribbon motor 29, and the like.

The processor 11 is connected to the ROM 12, the RAM 13, the data memory 14, the communication device 15, the display device 16, the operation device 17, the sensor group 21, the head driving device 22, the disconnection check circuit 25, the motor driving device 26, the ribbon driving device 28, and the like via a bus line. The bus line includes an address bus, a data bus, a control signal line, and the like. The processor 11 is configured to be connected to the respective units directly or via a signal input/output circuit through the bus line and transmit data signals exchanged between them.

The processor 11 is a hardware processor that integrally controls the label printer 1. The processor 11 controls the respective units in the label printer 1 in accordance with the operating system or the control program. The processor 11 is, for example, a central processing unit (CPU). The processor 11 may include a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA).

The ROM 12 is a non-volatile memory. The ROM 12 stores a program to be executed by the processor 11 and various types of data. The RAM 13 is a volatile memory. The RAM 13 is a memory that temporarily stores data. For example, the RAM 13 operates as a memory for development that temporarily stores a program and data when the processor 11 executes the program.

The data memory 14 corresponds to an auxiliary storage part. The data memory 14 is a rewritable non-volatile memory. The data memory 14 includes, for example, an electric erasable programmable read-only memory (EEPROM) (registered trademark), a hard disc drive (HDD), or a solid state drive (SSD). The data memory 14 stores data to be used by the processor 11 for performing various types of processing, data created by the processor 11 during the processing, and the like.

The communication device 15 is a communication interface for communicating with a host computer provided outside, a user terminal, or the like. For example, the communication device 15 is connected to the host computer for communication and receives print data for label printing and a print command supplied from the host computer.

The display device 16 includes a display device that displays information. The display device 16 is provided at a position where the display screen can be seen by the operator of the label printer 1. The display device 16 displays information indicating an operation instruction for the label printer 1, the state of the label printer 1, or the like.

The operation device 17 includes an input device for the operator to input an operation instruction. The input device as the operation device 17 is, for example, various input buttons, a touch panel, or the like. Further, the display device 16 and the operation device 17 may include a display device with a touch panel.

The printing mechanism 18 prints an image on a label as a medium by heating an ink ribbon by the thermal head 23. The sensor group 21 including various sensors is disposed in the printing mechanism 18. The sensor group 21 includes a sensor such as a sensor that detects a conveyed medium and a sensor that detects an ink ribbon. The processor 11 controls the respective units of the printing mechanism 18 on the basis of the detection result of each sensor of the sensor group 21, or the like.

The head driving device 22 is connected to the thermal head 23. The head driving device 22 drives the thermal head 23. The thermal head 23 is provided at a predetermined print position. The thermal head 23 includes a plurality of heating elements (elements) 24 arranged in a printing line orthogonal to the conveying direction of the medium at the print position. The thermal head 23 is disposed such that the plurality of heating elements 24 comes into contact with the ink ribbon that is superimposed on the label and conveyed, at the print position. The thermal head 23 prints on the label paper by applying heat to the ink ribbon that is superimposed on the label paper and conveyed by the individual heating elements 24 in the printing line.

The head driving device 22 causes each of the heating elements 24 constituting the thermal head 23 to generate heat on the basis of the print image. For example, the head driving device 22 controls the heat generation state of each heating element 24 in the thermal head 23 in accordance with the image data for each printing line in the print image of each page to be printed on a medium. The heating element 24 that has generated heat at a predetermined print position heats the ink ribbon pressed against the medium (label material). As a result, ink corresponding to the image data is transferred to the medium for each printing line.

The disconnection check circuit 25 is connected to each heating element 24 in the thermal head 23. Further, the disconnection check circuit 25 is also connected to the head driving device 22 and the processor 11. The disconnection check circuit 25 checks the presence or absence of disconnection (malfunction, defect) of each of the heating elements 24 constituting the thermal head 23 driven by the head driving device 22. For example, the disconnection check circuit 25 reads the resistance value for each heating element 24 and checks the presence or absence of disconnection of each heating element 24 by comparing the read resistance value with a predetermined threshold value (preset resistance value).

The motor driving device 26 is connected to the conveying motor 27. The motor driving device 26 drives the conveying motor 27 in accordance with an instruction from the processor 11. The conveying motor 27 conveys a medium on which an image is printed along a predetermined conveying path by causing a conveying roller to rotate. In this embodiment, the label printer 1 prints an image on a label material as a print medium on which an image is to be printed. For example, the conveying motor 27 conveys label paper in which a plurality of label materials is disposed on a long strip of mounting paper. The label paper is obtained by attaching a plurality of rectangular label materials to one surface of a long strip of mounting paper at predetermined equal intervals (e.g., approximately 1 to 3 mm). The label paper is set in a predetermined position in a roll form.

The ribbon driving device 28 is connected to the ribbon motor 29. The ribbon driving device 28 drives the ribbon motor 29 in accordance with an instruction from the processor 11. The ribbon motor 29 conveys an ink ribbon such that the ink ribbon is superimposed on the label paper at the print position. The ribbon motor 29 is a motor that causes a winding roller to rotate. Further, the ribbon motor 29 may include a motor that causes a feed roller to rotate and a motor that causes a winding roller to rotate. The ribbon motor 29 conveys the ink ribbon by causing the winding roller or both the feed roller and the winding roller to rotate.

For example, the feed roller winds an unused long ink ribbon into a roll. The winding roller winds the used ink ribbon that has passed through the print position into a roll. The ink ribbon is conveyed between the feed roller and the winding roller such that it passes through the print position and is superimposed on the label paper. The ribbon driving device 28 controls the ribbon motor 29 such that the ink ribbon is conveyed at the same conveying speed and the same direction as those of the label paper at the print position.

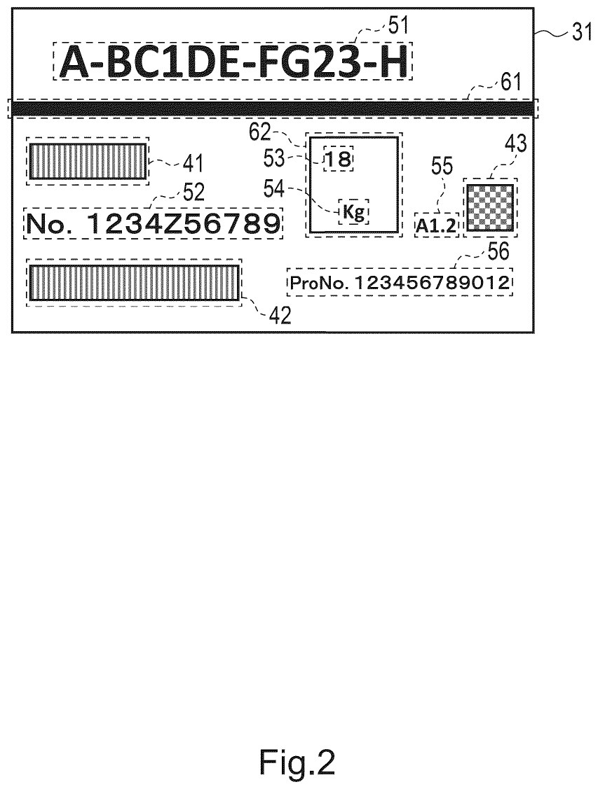

Next, a print image that is printed on a label material as a print medium by the printing mechanism 18 of the label printer 1 according to the embodiment will be described. FIG. 2 is a diagram showing an example of a print image that is printed on a label material 31 as a print medium by the label printer 1 according to the embodiment. The print image printed on the label material 31 by the label printer 1 is formed in a predetermined print format. As illustrated in FIG. 2, the print image is formed in a print format having a plurality of image regions. For example, the label printer 1 acquires a print image for each page to be printed on the label material 31 from a host computer 2. In this case, the host computer 2 selects the print format of the print image designated by the operator. The host computer 2 generates a print image of each page by setting an image for each page (a barcode, a two-dimensional code, a character, a symbol) in each image region of the selected print format.

The desired print quality of the print image differs for each image region of the print format in some cases. For example, there is a possibility that information of a two-dimensional code or a barcode cannot be recognized accurately if there are missing prints or the like. For this reason, an image region where a two-dimensional code or a barcode is printed often requires high print quality. Further, it is highly likely that an image intended to be viewed by humans, such as a character and a mark, is likely can be visually recognized by humans even if there are some missing prints. For this reason, an image region on which an image intended to be viewed by humans, such as a character and a mark, is printed often requires print quality that allows it to be visually recognized by humans. Further, an image such as grid lines often does not cause problems of the function of a label as a printed matter in which a print image is printed on a label material, even if there are missing prints. For this reason, an image region where an image such as grid lines is printed often does not require high print quality.

In this embodiment, in the print image, a priority setting is made for each image region in accordance with print quality required for each image region in the print format. For example, a high priority setting that does not allow any missing print is made for the image region where a two-dimensional code or a barcode is to be printed. A priority setting that allows some missing prints is made for the image region where an image intended to be viewed by humans, such as a character and a mark, is to be printed. A priority setting that eliminates the necessity to check missing prints is made for the image region where an image such as grid lines is to be printed.

Meanwhile, in the label printer 1, the causes of missing prints include malfunctions in heat generation of the heating elements 24 in the thermal head 23. The malfunction of each heating element 24 in the thermal head 23 can be detected by a disconnection check using the disconnection check circuit 25. Further, the disconnection check is an operation of checking the malfunction of each individual heating element 24 in the thermal head 23. As the disconnection check, each heating element 24 in a specific range (specific section in the printing line) may be checked and whether or not there is a missing print may be checked only in a specific image region.

The label printer 1 acquires a print image and information indicating a priority setting relating to the disconnection check for each image region in the print image. The label printer 1 determines the necessity and content of the disconnection check in accordance with the priority setting in each image region. The priority setting for each image region in the print image is made before printing is executed by the label printer 1.

For example, the host computer 2 supplies, in the case of requesting the label printer 1 to print, a print image and information indicating a priority setting for each image region. Further, the label printer 1 may also store the priority setting for each image region for each print format. In this case, the label printer 1 may identify the priority setting for each image region in the print image in accordance with the designated print format.

As a specific example, the print image illustrated in FIG. 2 has a plurality of image regions 41 to 43, 51 to 56, 61, and 62. In this case, the priority setting for each image region will be described as being set to either “High”, “Low”, or “None (no disconnection check required)”.

The image regions 41 and 42 each indicate the printing region of a barcode, and the image region 43 indicates the printing region of a two-dimensional code. There is a possibility that in these image regions 41 to 43, the information indicating the code cannot be recognized accurately if there are missing prints. For this reason, it is conceivable that the priority settings for the image regions 41 to 43 are set to “High”.

The image regions 51 to 56 are each a region where a character or a symbol to be viewed by humans is printed. It is likely that the images printed in these image regions 51 to 56 can be recognized by humans even if there are some missing prints. For this reason, it is conceivable that the priority settings for the image regions 51 to 56 are set to “Low”.

The image regions 61 and 62 are each a region where grid lines or the like are printed. The images printed on the image regions 61 and 62 do not cause problems of the function of a label as a print image even if there are missing prints. For this reason, it is conceivable that the priority settings for the image regions 61 and 62 are set to “None (no disconnection check required)”. The image region for which the priority setting has been set to “None” is set to “unnecessary” of a disconnection check.

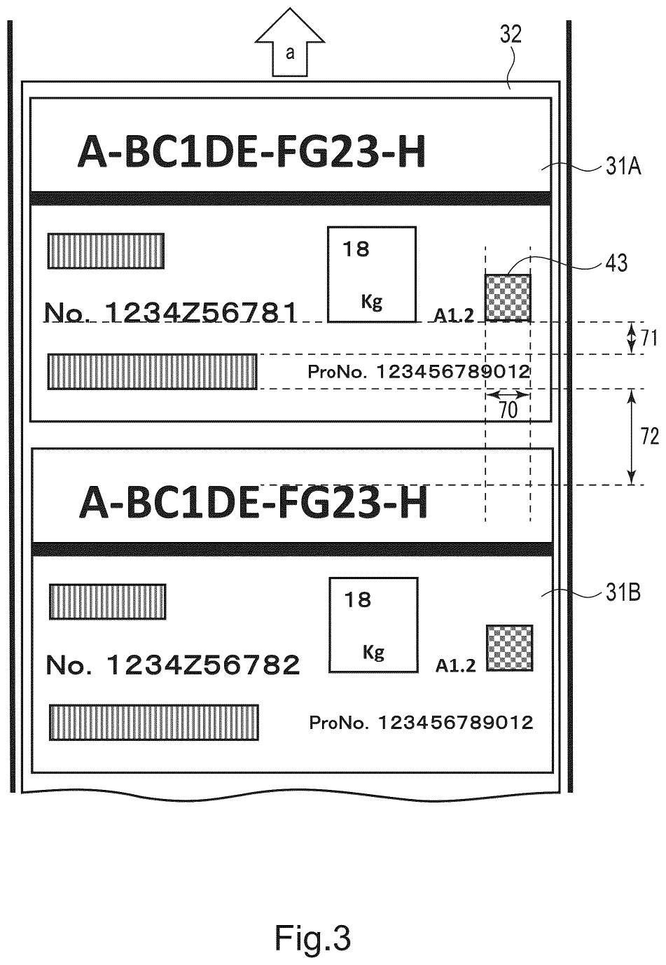

Next, an unprinted region in the print image, which enables a disconnection check during the execution of print processing, will be described. FIG. 3 is a diagram showing an example in which a print image has been printed on each of a plurality of label materials 31 (31A and 31B) in label paper 32 by the label printer 1. As shown in FIG. 3, in the label paper 32, the plurality of label materials 31A and 31B is arranged at predetermined intervals on the long mounting paper. In the printing mechanism 18, the label paper 32 in which the plurality of label materials 31A and 31B is arranged side by side is conveyed in the direction indicated by an arrow a shown in FIG. 3 (conveying direction).

The plurality of heating elements (element group) constituting the thermal head 23 is arranged in the direction orthogonal to the conveying direction a of the label paper 32 at a predetermined print position. That is, the element group of the thermal head 23 prints an image for each line (printing line) in the direction orthogonal to the conveying direction a on the label material 31A conveyed in the conveying direction a.

As shown in FIG. 3, the print image printed on the label material 31 by the label printer 1 has a region (unprinted region) where a printing line with no pixel to be printed is continuous in some cases. The disconnection check can be performed in the case where there is no heating element that generates heat for printing in the group of heating elements in the thermal head 23. That is, even during the conveyance of the label paper 32, the disconnection check can be performed in the case of an unprinted region where all of the group of heating elements in the thermal head 23 are not used to print.

For example, focusing on the image region 43 on the label material 31A in the print image shown in FIG. 3, an unprinted region 71 follows the printed image region 43. Further, in the conveying direction a, the section from the end position of printing on the label material 31A to the start position of printing on the label material 31B corresponds to an unprinted region 72. The disconnection check for the image region 43 can be performed during the period in which the unprinted region 71 passes through the print position and the period in which the unprinted region 72 passes through the print position.

Further, the image of the image region 43 is printed by the heating element group 24 arranged in a section 70 in the printing line orthogonal to the conveying direction a. That is, in the case where only the image region 43 is a target of the disconnection check, the disconnection check only needs to be performed for each of the heating elements 24 arranged in the section 70. That is, the disconnection check for the image region 43 only needs to be executed on the heating elements 24 arranged in the section 70 during the period in which each of the unprinted region 71 and the unprinted region 72 passes through the print position.

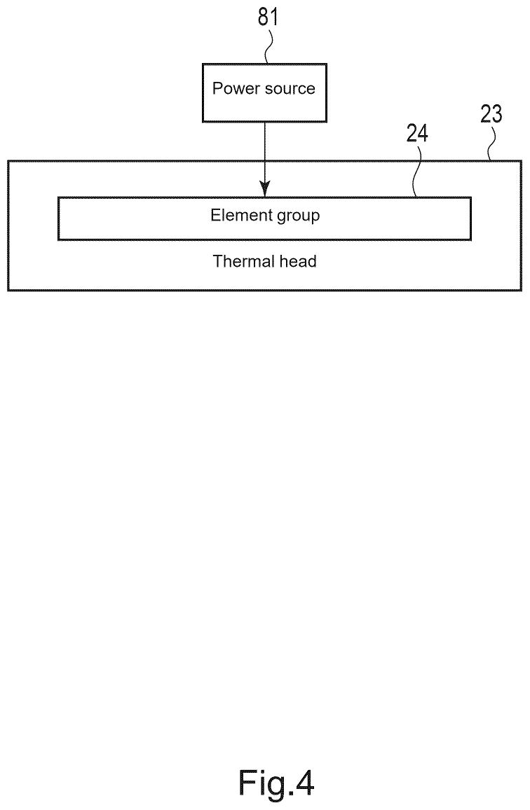

Next, a configuration of the heating element group 24 of the thermal head 23, which is a target of the disconnection check, in the label printer 1 according to the embodiment will be described. FIG. 4 is a diagram showing a first configuration example of the heating element group 24 included in the thermal head 23 used in the label printer 1 according to the embodiment. In the first configuration example shown in FIG. 4, the thermal head 23 includes the heating element group (element group) 24 arranged side by side in the printing line at the print position. The element group 24 is connected to one power source 81.

Since the element group 24 in the first configuration example is connected to the one power source 81, the disconnection check cannot be performed unless the entire printing line is unprinted. That is, in the case where the element group 24 arranged in the entire printing line is connected to the one power source 81, the disconnection check can be performed during the period in which the entire printing line is unprinted.

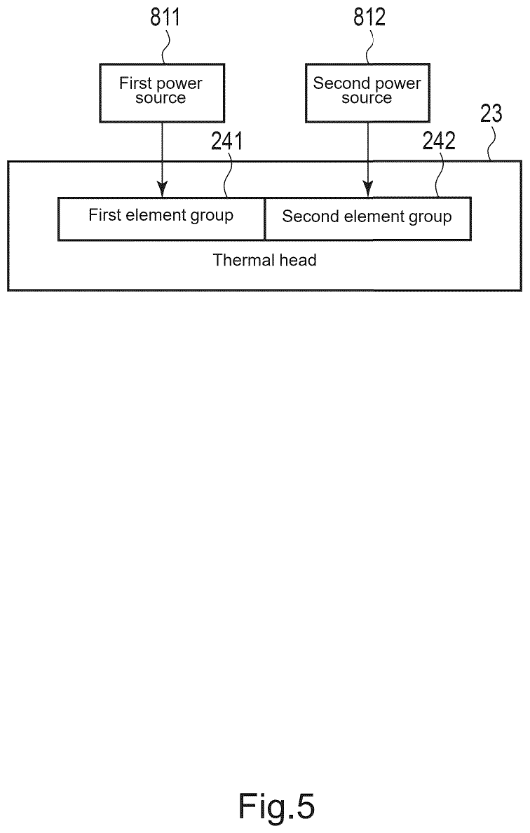

FIG. 5 is a diagram showing a second configuration example of the heating element group 24 (241, 242) in the thermal head 23 used in the label printer 1 according to the embodiment. In the second configuration example shown in FIG. 5, the thermal head 23 includes a first element group 241 and a second element group 242. The first element group 241 is disposed at the position from one end portion of the printing line to the half (left half). The second element group 242 is disposed at the position from the other end portion of the printing line to the half (right half). That is, the first element group 241 and the second element group 242 are arranged side by side in the entire printing line. The first element group 241 is connected to a first power source 811. The second element group 242 is connected to a second power source 812 that is capable of operating independently of the first power source 811.

Since the first element group 241 and the second element group 242 in the thermal head 23 in the second configuration example are connected to separate power sources, each of them can perform the disconnection separately. That is, the disconnection check for the first element group 241 can be performed in the period in which the left half of the printing line is unprinted regardless of the presence or absence of printing in the right half of the printing line. Further, the disconnection check for the second element group 242 can be performed in the period in which the right half of the printing line is unprinted regardless of the presence or absence of printing in the left half of the printing line. In the case where the entire printing line is unprinted, the disconnection check can be executed on both the first element group 241 and the second element group 242.

Note that the thermal head 23 does not necessarily need to have the configuration illustrated in FIG. 5 and may include a plurality of element groups and power sources. The disconnection check for each of the element groups connected to the separate power sources can be performed in the period in which the region corresponding to the element group that is a target of the disconnection check is unprinted.

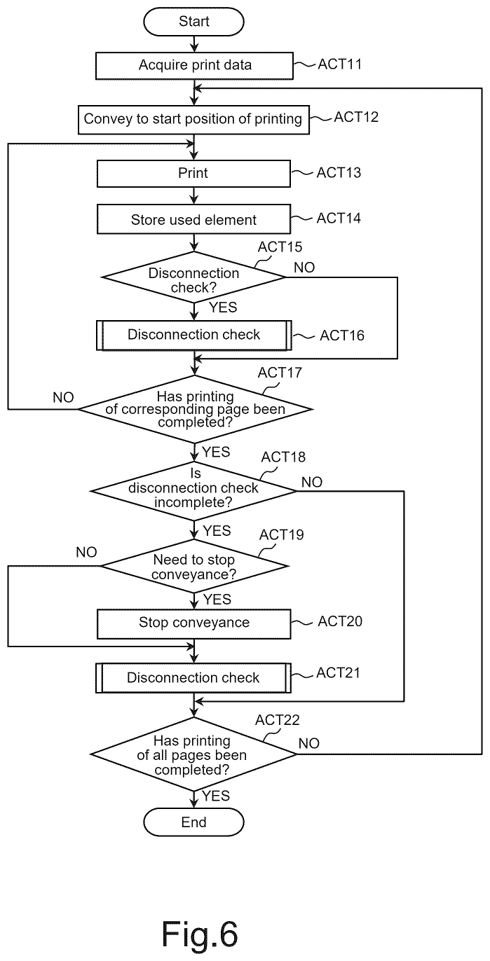

Next, a printing operation including the disconnection check corresponding to the priority setting for each image region in a print image by the label printer 1 will be described. FIG. 6 is a flowchart describing a printing operation including a disconnection check corresponding to a priority setting for each image region by the label printer 1. First, the processor 11 of the label printer 1 acquires print data in the case of executing printing (ACT11). For example, the processor 11 of the label printer 1 acquires a print request and print data from the host computer 2. The print data includes a print image and information indicating a priority setting for each image region in the print image. The processor 11 expands the print image included in the print data into image data for each printing line and stores them in a memory such as the RAM 13.

The processor 11 conveys the label material 31 to the start position of printing in order to print a print image for each page on the label material 31 as a print medium (ACT12). For example, the processor 11 conveys the label material 31 arranged on label paper to the start position of printing by driving the conveying motor 27 by the motor driving device 26 to convey the label paper 32.

When the label material 31 reaches the start position of printing, the processor 11 executes printing for each printing line while conveying the label material 31 at a predetermined conveying speed (ACT13). For example, the processor 11 controls the heat generation of each heating element 24 using the head driving device 22 at timing corresponding to the conveying speed in accordance with the image data of the printing line. As a result, an image corresponding to the image data is printed on the label material 31 conveyed in the conveying direction for each printing line at the print position.

The processor 11 stores, when printing the image data in the printing line, information indicating the heating element (used element) 24 that has generated heat in the RAM 13 or the data memory 14 (ACT14). For example, the processor 11 provides a table indicating the presence or absence of use for each heating element 24 in the RAM 13 or the data memory 14 and stores information indicating the used heating element (used element).

The processor 11 determines, each time printing in each printing line is completed, whether or not a disconnection check in an unprinted region in the print image can be performed (ACT15). The processor 11 sets the period in which the unprinted region in the print image passes through the print position (printing line) as a period in which a disconnection check can be performed. For example, the processor 11 calculates the period in which the unprinted region passes through the print position on the basis of the print data, the conveying speed, and the like. The processor 11 sets the period in which a disconnection check can be performed, in advance on the basis of the calculated period in which the unprinted region passes through the print position.

In the case where it is determined that the disconnection check in the unprinted region in the print image can be performed (ACT15, YES), the processor 11 executes a disconnection check (ACT16). The disconnection check in ACT16 is processing executed in the period in which the unprinted region in the print image in the corresponding page passes through the print position. The processor 11 sets, on the basis of the priority setting for each image region in the print image, a heating element group on which the disconnection check is to be executed. The heating element group on which a disconnection check is to be executed is a heating element group arranged in the section in which the image of the image region on which the disconnection check is to be executed is to be printed. The processor 11 executes the disconnection check described below in detail for each heating element for which a disconnection check is to be executed.

Note that the disconnection check in ACT16 is processing executed in the period in which the unprinted region in the print image passes through the print position. In the case where the period in which the unprinted region passes through the print position ends (in the case of resuming printing), the processor 11 performs control to interrupt the disconnection check if the disconnection check has not been completed, and the processing proceeds to ACT17. In the case of interrupting the disconnection check, the processor 11 stores the information indicating the heating element on which the disconnection check has been completed in the RAM 13 or the data memory 14.

In the case where it is determined that the disconnection check in the unprinted region in the print image cannot be performed (ACT15, NO), the processor 11 determines whether or not the printing of the print image in the corresponding page has been completed (ACT17). Further, in the case where the disconnection check in ACT16 has been completed or the disconnection check is interrupted, the processor 11 determines whether or not the printing of the print image in the corresponding page has been completed. In the case where the printing of the print image in the corresponding page has not been completed (ACT17, NO), the processing returns to ACT13 and the processor 11 executes printing of the next printing line in the print image in the corresponding page.

In the case where the printing of the print image in the corresponding page has been completed (the final printing line in the corresponding page has been printed) (ACT17, YES), the processor 11 determine whether or not the disconnection check is incomplete (ACT18). In the case where the disconnection check has been completed (ACT18, NO), the processor 11 determines whether or not printing of all pages has been completed (ACT22). In the case where printing of all pages has not been completed (ACT22, NO), the processing returns to ACT12 and the processor 11 executes printing of the print image in the next page. Further, in the case where printing of all pages has been completed (ACT22, YES), the processor 11 ends the series of printing operations.

In the case where the disconnection check has not been completed (ACT18, YES), the processor 11 determines whether to stop the conveyance of the label material (printing operation) in order to perform the disconnection check (ACT19). The processor 11 determines whether to stop the printing operation on the basis of whether or not the disconnection check can be completed in the unprinted region from the end position of printing the print image in the corresponding page to the start position of printing in the next page.

For example, the processor 11 estimates, from the number of heating elements on which the disconnection check is to be executed, the status of the disconnection check being performed, or the like, the time required for the disconnection check to be executed after printing the page (disconnection check time after page printing). The processor 11 determines, from the disconnection check time after page printing, the conveying speed of the label material, the size of the unprinted region (length in the conveying direction), or the like, whether or not the disconnection check is to be completed without stopping the printing operation.

However, depending on the printing speed or the like, the disconnection check cannot be completed in some cases before the start of printing in the next page even if the size of the unprinted region is sufficiently large. In such a case, the unprinted region from the top of the next page to the start position of printing in the next page (overlap region), which is included in the unprinted region where the disconnection check can be executed, is restricted. In this case, the processor 11 determines, on the basis of the unprinted region of the end of the corresponding page and the restricted overlap region in the next page, whether or not the disconnection check will be completed.

In the case where it is determined that the conveyance of the label material as a print medium (printing operation) is to be stopped (ACT19, YES), the processor 11 stops the conveyance of the label material by the conveying motor 27 (ACT20). The processor 11 stops the printing operation such that the label material on which the print image of the next page is to be printed is stopped at the position where the printing of the next page can be smoothly resumed. For example, the processor 11 stops the printing operation by stopping the label material on which the print image of the next page is to be printed at the start position of printing in the next page.

In the case of stopping the printing operation, the processor 11 performs control of stopping the label material in the next page at a predetermined position and performs the disconnection check (ACT21). In this example, since there is printing in the next page (ACT22, NO), the processing proceeds to ACT12 when the disconnection check is completed and the processor 11 restarts the printing on the label material in the next page.

In the case where it is determined that the printing operation (conveyance of the label paper) is not to be stopped (ACT19, NO), the processor 11 executes the disconnection check while continuing the printing operation (ACT21). In this case, the processing proceeds to ACT12 after the disconnection check is completed if there is printing in the next page (ACT22, NO), and the processor 11 causes the label material in the next page to the start position of printing to execute printing in the next page. In this case, the processor 11 may backfeed the label paper as necessary to cause the label material in the next page to move to the print start position before starting printing in the next page.

Further, in the case where the disconnection check in ACT21 has been completed, the processor 11 ends the series of printing operations if there is no printing image of the next page (ACT22, YES).

As described above, the label printer according to the embodiment determines whether or not it is necessary to check disconnection on the basis of a priority setting for each image region in a print image. The label printer executes a disconnection check using a disconnection check circuit for a heating element that is determined to need to be subjected to a disconnection check on the basis of the priority setting for each image region.

As a result, the label printer according to the embodiment is capable of performing a disconnection check only on the heating element that needs to be subjected to a disconnection check. As a result, the label printer according to the embodiment is capable of shortening the time required for the disconnection check performed in parallel with the printing operation and executing the entire printing operation including the disconnection check in a short time.

Further, the label printer according to the embodiment executes the disconnection check using the disconnection check circuit in a period in which an unprinted region in a print image of each page passes through a print position. As a result, the label printer according to the embodiment is capable of executing a disconnection check during the printing operation such as convenance of the print medium without stopping the printing operation. As a result, the label printer according to the embodiment is capable of speeding up the entire printing operation including the disconnection check.

Further, in the case where print images of a plurality of pages are continuously printed, the label printer according to the embodiment executes the disconnection check in a period from the end of printing in one page to the start of printing in the next page. As a result, even if there are few unprinted regions in the print image, the label printer according to the embodiment is capable of executing the disconnection check while reducing the stopping of the printing operation. As a result, the label printer according to the embodiment is capable of speeding up the entire printing operation including the disconnection check.

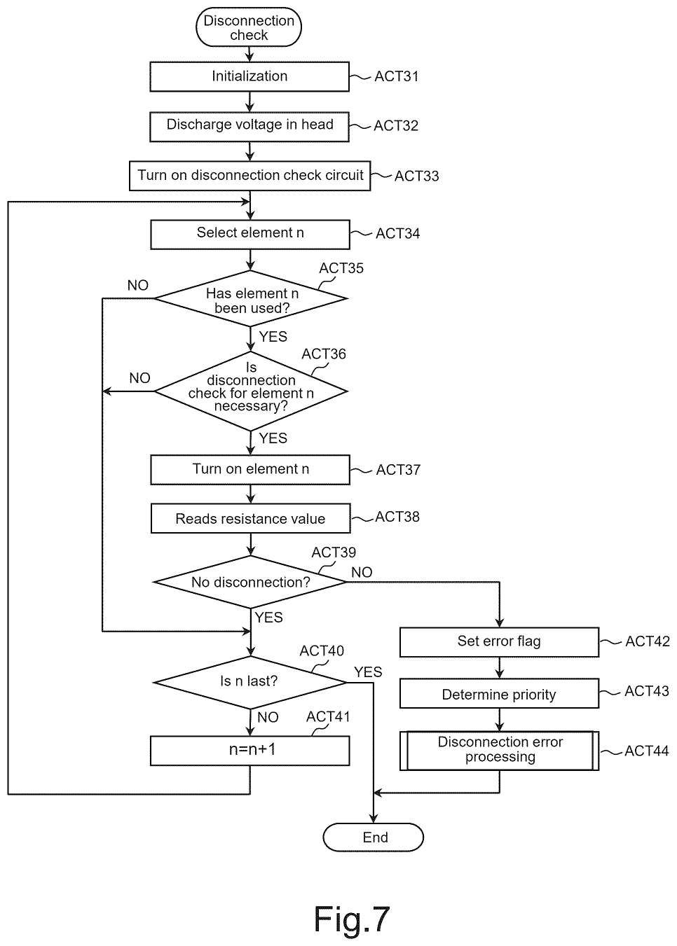

Next, an operation of the disconnection check in the label printer 1 as the image forming apparatus according to the embodiment will be described. FIG. 7 is a flowchart describing an operation example of a disconnection check in the label printer 1 according to the embodiment. In the case of starting a disconnection check, the processor 11 performs initialization for executing the disconnection check (ACT31). The processor 11 performs settings such that power for a disconnection check is supplied to the heating element group 24 of the thermal head 23. Further, the processor 11 sets a variable n for designating the heating element 24 on which a disconnection check is to be actually performed to its initial value. In the example shown in FIG. 3, the processor 11 sets the initial value of the variable n such that the section 70 is a target of the disconnection check and the heating element 24 located at the position corresponding to the section 70 is designated in order.

Further, the processor 11 discharges the voltage in the circuit of the head driving device 22 and the thermal head 23 while performing the initialization (ACT32). When the voltage of the circuit is discharged, the processor 11 turns on the disconnection check circuit 25 (ACT33), and sets the n-th heating element (element n) as a target of the disconnection check (ACT34).

When the element n is selected, the processor 11 determines whether or not the element n has executed printing (has been used) (ACT35). For example, the processor 11 stores, as the processing in ACT14, information indicating each element used during the execution of printing in the memory such as the RAM 13. The processor 11 determines, on the basis of the information stored in the memory in ACT14, whether or not the element n has been used.

In the case where the element n has not been used (ACT35, NO), the processor 11 skips (omits) the disconnection check for the element n and the processing proceeds to ACT40. In the case where the element n has been used (ACT35, YES), the processor 11 determines, on the basis of the priority setting for the image region, whether or not it is necessary to perform a disconnection check on the element n (ACT36). For example, the processor 11 determines whether or not the element n is an element disposed at the position corresponding to the image region that needs to be subjected to a disconnection check as a priority setting.

In the case where the element n is not disposed at the position corresponding to the image region that needs to be subjected to a disconnection check, the processor 11 determines that a disconnection check is unnecessary. In the case where a disconnection check for the element n is unnecessary (ACT36, NO), the processor 11 skips (omits) the disconnection check for the element n and the processing proceeds to ACT40.

In the case where the element n is disposed at the position corresponding to the image region that needs to be subjected to a disconnection check, the processor 11 determines that a disconnection check is necessary. In the case where it is determined that a disconnection check for the element n is necessary (ACT36, YES), the processor 11 turns on the element n (ACT37) and reads a resistance value by the disconnection check circuit 25 (ACT38).

The disconnection check circuit 25 outputs, to the processor 11, a signal indicating whether or not the resistance value when the element n is on is a value indicating the disconnection (malfunction). The processor 11 determines, on the basis of the output from the disconnection check circuit 25, whether or not there is a disconnection (malfunction) in the element n (ACT39).

In the case where it is determined that there is no disconnection in the element n (ACT39, YES), the processor 11 determines whether or not the n is the last (ACT40). The processor 11 determines whether or not the n-th element is the last element on which a disconnection check is to be performed. When the variable n is the last (ACT40, YES), the processor 11 ends the disconnection check.

When the variable n is not the final (ACT40, NO), the processor 11 increments the variable n (n=n+1), the processing returns to ACT34, and a disconnection check for the next element is performed.

However, the processor 11 monitors whether it is the period in which a disconnection check can be performed while executing the disconnection check. In the case where the period in which a disconnection check can be executed ends while executing the disconnection check, the processor 11 interrupts the disconnection check, the processing returns to ACT17, and the printing is resumed.

Further, in the case where a disconnection (malfunction) of the element n has been detected (ACT39, NO), the processor 11 sets information (error flag) indicating the element n from which the disconnection has been detected (ACT42). For example, the processor 11 stores the error flag indicating the disconnection of the element n in the memory such as the RAM 13 and the data memory 14. When the error flag is set in the memory, the processor 11 determines a priority setting for the image region corresponding to the element n from which the disconnection has been detected (ACT43) and executes disconnection error processing corresponding to the determined priority setting (ACT44).

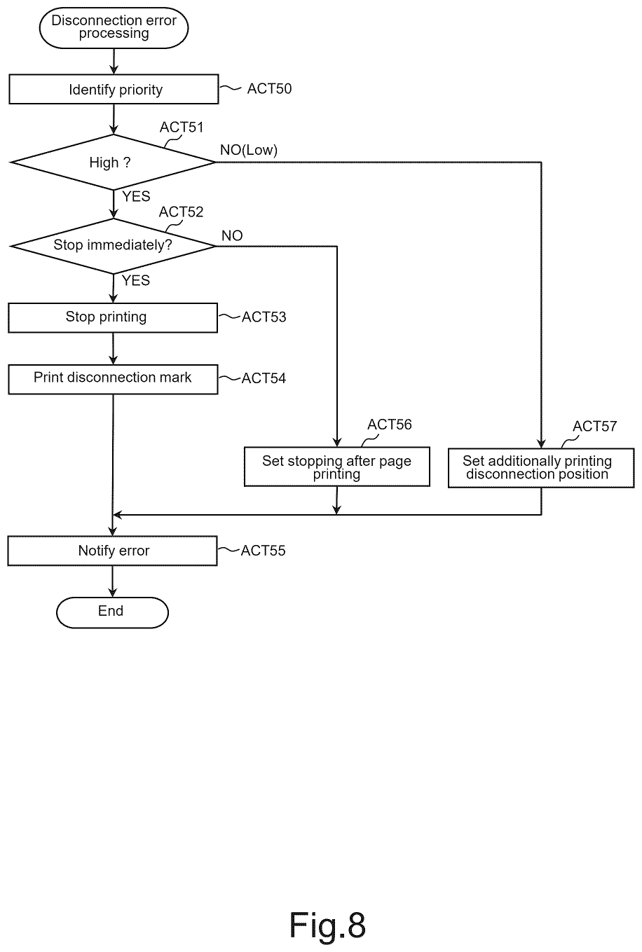

Next, an operation of the disconnection error processing in the label printer 1 according to the embodiment will be described. FIG. 8 is a flowchart describing an operation example of the disconnection error processing in the label printer 1 according to the embodiment. The processor 11 executes error processing (disconnection error processing) corresponding to a priority setting for the image region corresponding the to element from which a disconnection has been detected. The content of the disconnection error processing is stored in the data memory 14 as setting information corresponding to a priority setting in advance.

In this example, as the priority setting for each image region, not only the presence or absence of a disconnection check but also the priority level is set. In the following description, the priority settings for each image region are set to either “No disconnection check (None)”, “High”, or “Low”. No disconnection check is performed on the heating element (element) in which the priority settings for all image regions including pixels to be printed are “No disconnection check”. That is, the disconnection check is executed on the heating element that has printed a pixel included in the image region whose priority setting is “High” or “Low”.

When a disconnection is detected in the disconnection check, the processor 11 identifies the priority of the heating element from which the disconnection has been detected (ACT50). In this example, the priority of each heating element conforms to the highest priority setting for the image region including the pixel group to be printed. That is, the processor 11 determines whether the priority of the heating element from which the disconnection has been detected is “High” or “Low”.

For example, in the case where the image region including a pixel to be printed by the heating element includes an image region whose priority setting is “High”, the priority of the heating element is set to “High”. In the case where the image region including a pixel to be printed by the heating element does not include an image region whose priority setting is “High” but includes an image region whose priority setting is “Low”, the priority of the heating element is set to “Low”.

In the case where it is determined that the priority of the heating element from which the disconnection has been detected is “High” (ACT51, YES), the processor 11 executes error processing corresponding to the heating element whose priority is “High”. The data memory 14 stores setting information indicating the content of error processing (high-priority error processing) of the case where the priority of the heating element from which the disconnection has been detected is “High”.

For example, as the high-priority error processing, the timing at which the printing operation of the print image is stopped, the print content of the print defect mark described below, or the like is set. In this example, as the high-priority error processing, the timing at which the printing operation is stopped is set to either “immediately” or “at the end of page printing”. In this case, the processor 11 determines, as the high-priority error processing, whether the printing operation of the print image is to be stopped immediately or at the end of page printing (ACT52).

In the case where it is determined that the printing operation is to be stopped immediately (ACT52, YES), the processor 11 immediately stops the printing operation of the print image being executed (ACT53). The processor 11 stops the conveyance of the label paper on which the label material as a print medium has been placed and stops the driving of the thermal head 23 by the head driving device 22.

In the case where the printing operation is stopped immediately, the processor 11 prints information (print defect mark) indicating that there is a missing print in the image printed on the label material (disconnection of the heating element has been detected) (ACT54). For example, the processor 11 backfeeds, by the conveying motor 27, the label material whose printing has been stopped after immediately stopping the printing operation. The processor 11 causes the label material to move to the start position of printing or the start position of printing the print defect mark by the backfeeding.

When the label material moves to the start position of printing or the start position of printing the print defect mark, the processor 11 conveys the label material in a predetermined conveying direction at a predetermined print speed again. The processor 11 prints the print defect mark on the label material by controlling the heat generation of each heating element of the thermal head 23 while conveying the label material in the predetermined conveying direction.

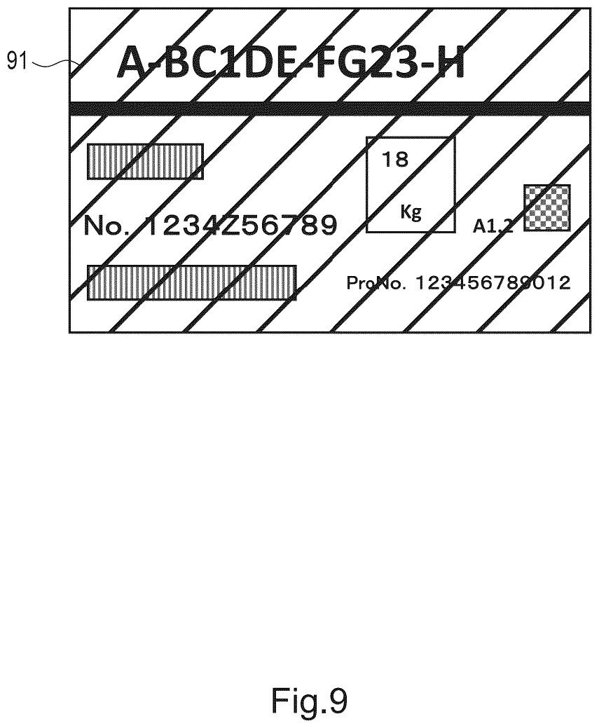

FIG. 9 is a diagram showing an example of a print defect mark 91 to be printed on the label material in the case where a disconnection (malfunction) has been detected from the heating element whose priority is “High”. The print defect mark 91 indicates that it is a label in which the image region whose priority setting is “High” is printed by the heating element from which the disconnection (malfunction) has been detected. In the label on which the print defect mark 91 has been printed, the print defect mark 91 printed to be superimposed on the printed image clearly shows that the label is unusable (there is a missing print).

Note that the print defect mark 91 illustrated in FIG. 9 is diagonal lines printed on the entire label material on which the print image has been printed. However, the print defect mark 91 only needs to be a mark indicating that the image region whose priority setting is “High” is printed by the element with a malfunction and is not limited to the one exemplified in FIG. 9. For example, as the print defect mark, various mark may be set. A character string such as “VOID” set by a user may be printed on the label material.

Further, in the case where a disconnection of the heating element has been detected, the processor 11 notifies of an error indicating that a disconnection of the heating element has been detected (ACT55). For example, the processor 11 displays, on the display device 16, an error notification screen displaying information indicating the position of the heating element from which the disconnection has been detected.

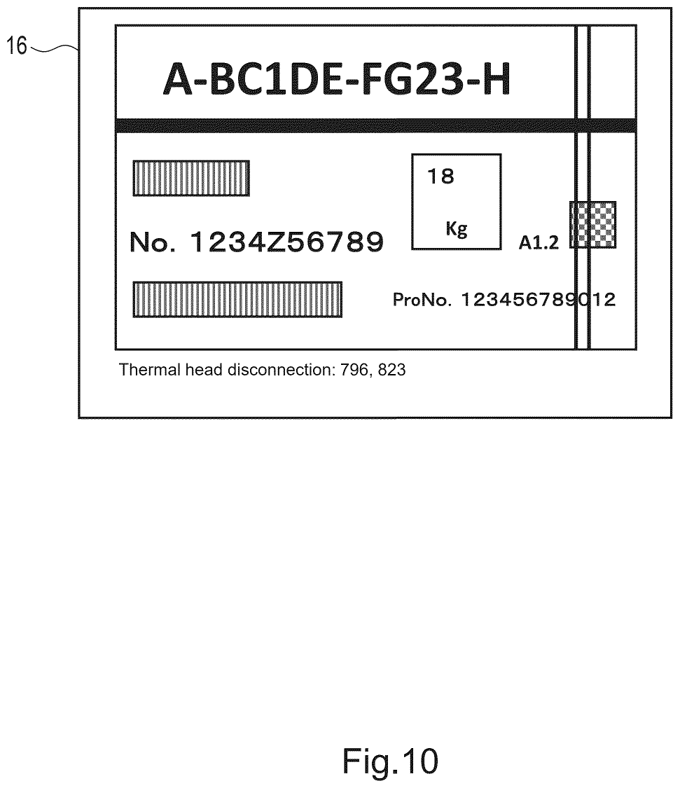

FIG. 10 is a diagram showing a display example of the error notification screen displayed on the display device 16 in the case where a disconnection of the heating element has been detected in the disconnection check. In the example shown in FIG. 10, the display device 16 displays, as the error notification screen, information indicating the heating element whose disconnection (malfunction) has been detected in the disconnection check in the thermal head 23. In the display example shown in FIG. 10, character information indicating the position of the heating element from which a disconnection has been detected and a solid line indicating the position in the print image are shown. This allows the operator to clearly confirm the heating element from which the disconnection has been detected.

Further, the processor 11 may notify, by the communication device 15, the host computer 2 of that the disconnection of the heating element has been detected. For example, the processor 11 may notify, in the case where the printing operation is stopped, the host computer 2 of that the printing operation is stopped because the disconnection of the heating element has been detected. As a result, the host computer 2 is capable of recognizing, by the notification from the label printer 1, that the printing is stopped due to the detection of the disconnection of the heating element.

Further, in the case where it is determined that the printing operation is to be stopped not immediately but at the end of page printing (ACT52, NO), the processor 11 performs a stop setting to stop the printing operation at the end of page printing (ACT56). In the case of the stop setting at the end of page printing is performed, the processor 11 continues the printing operation of the print image in the corresponding page and stops the printing operation when the printing of the print image in the corresponding page is completed.

As the stop setting, not only stopping the printing operation at the end of page printing but also printing the print defect mark 91 as shown in FIG. 9 on the label material may be set. In the case of the stop setting including printing a print defect mark, the processor 11 executes processing of stopping the printing operation at the end of page printing and then printing a print defect mark on the label material.

Further, in the case where it is determined that the printing operation is to be stopped at the end of page printing, the processor 11 also notifies of an error indicating the heating element from which the disconnection has been detected (ACT55). For example, the processor 11 displays, on the display device 16, the above-mentioned error notification screen as shown in FIG. 10. Further, the processor 11 may display, on the display device 16, an error notification screen including not only the information indicating the heating element from which the disconnection has been detected but also a message indicating that the printing operation will be stopped at the end of page printing.

Note that in the case where the above-mentioned stop setting at the end of page printing is made, the processor 11 only needs to continue the printing operation of the print image in the corresponding page while notifying of an error. In this case, the processor 11 executes the operation based on the above-mentioned stop setting after the printing operation of the print image in the corresponding page is completed. As a result, even if the priority of the heating element from which the disconnection has been detected is “High”, the processor is capable of stopping the printing operation at the end of printing the corresponding page while notifying of an error.

Further, in the case where the priority of the heating element from which the disconnection has been detected is “Low”, (ACT51, NO), the processor 11 executes error processing (low-priority error processing) corresponding to the priority of “Low”. The data memory 14 stores setting information indicating the content of the error processing of the case where the priority of the heating element from which the disconnection has been detected is “Low”. In this example, as the low-priority error processing, additionally printing information indicating that there is a disconnection (missing print) in the print image without stopping the printing operation is set. In this case, the processor 11 sets additionally printing information indicating that there is a heating element form which a disconnection has been detected while continuing the printing operation on the basis of the setting information (ACT57).

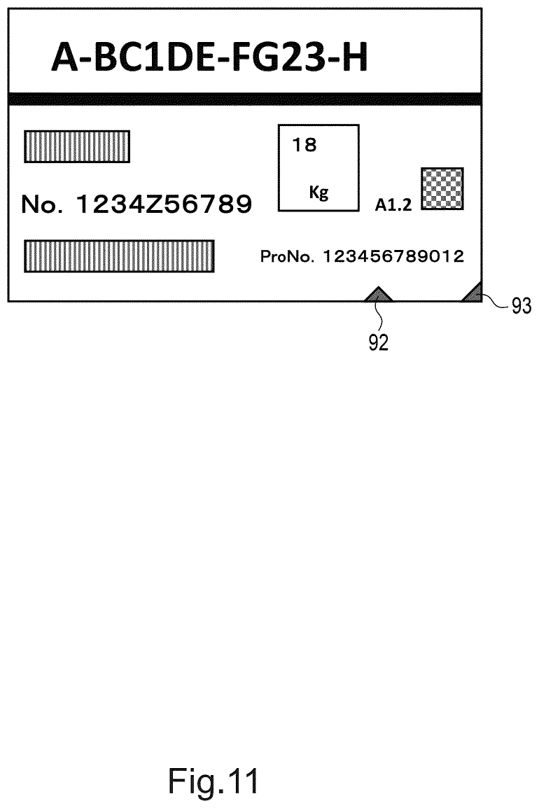

FIG. 11 is a diagram showing an example of information to be additionally printed in the case where a disconnection of the heating element corresponding to the image region whose priority setting is “Low” has been detected. In the example shown in FIG. 11, as the low-priority error processing, a position mark 92 and a missing print mark 93 are additionally printed to be superimposed on the printed image.

The position mark 92 is a mark indicating the print position of the heating element (heating element whose priority is “Low”) from which a disconnection has been detected. The label on which the position mark 92 has been printed can clearly indicate that there is a possibility that there is a missing print at the position indicated by the position mark 92.

Further, the missing print mark 93 indicates that the print image is printed using the thermal head including the heating element from which a disconnection has been detected. Since there is a missing print in the case of using the heating element from which a disconnection has been detected, the missing print mark 93 is a mark indicating that there is a missing print. The label on which the missing print mark 93 has been printed can clearly indicate that there is a possibility that there is a portion with a missing print in the printed image.

Further, in the example shown in FIG. 11, the position mark 92 and the missing print mark 93 are printed in the regions subsequent to the print end line of the print image in the corresponding page. As a result, the marks 92 and 93 can be additionally printed after the printing of the print image in the corresponding page is completed. That is, even if the additional printing of the marks 92 and 93 is set during the printing operation of the print image, it is possible to additionally print the marks 92 and 93 without stopping the printing operation.

Note that the information to be additionally printed only needs to be information indicating that it is printed by the thermal head 23 including the heating element from which a disconnection has been detected, and is not limited to the one illustrated in FIG. 11. For example, the information to be additionally printed may be either the position mark 92 or the missing print mark 93, may be another mark, or may be a character string or the like.

Further, in the case where the additional printing has been set, the processor 11 also notifies of an error indicating the heating element from which the disconnection has been detected (ACT55). For example, the processor 11 displays, on the display device 16, the above-mentioned error notification screen as shown in FIG. 10. Further, the processor 11 may display, on the display device 16, not only the information indicating the heating element from which the disconnection has been detected but also a message indicating that the printing operation of the print image is continued.

Note that in the case where the above-mentioned additional printing has been set, the processing returns to ACT40 after notifying of an error, the processor 11 continues the printing operation of the print image. As a result, in the case where the priority of the heating element from which the disconnection has been detected is “Low”, the processor 11 is capable of continuing the printing operation while notifying of an error and performing the additional printing on the label.

As described above, the label printer according to the embodiment executes a disconnection check for the heating element determined to need to be subjected to a disconnection check on the basis of the priority setting for each image region. When a disconnection of the heating element is detected in the disconnection check, the label printer according to the embodiment performs error processing corresponding to the priority setting for the image region printed by the heating element from which the disconnection has been detected. As a result, the label printer according to the embodiment is capable of executing error processing corresponding to the print quality required for the image region printed by the heating element from which the disconnection has been detected.

Further, in the case where the priority setting of the image region corresponding to the heating element from which a disconnection has been detected is “High”, the label printer according to the embodiment stops the printing operation and notifies of an error. Further, in the case where the priority setting of the image region corresponding to the heating element from which a disconnection has been detected is “Low”, the label printer according to the embodiment notifies of an error while continuing the printing operation.

As a result, the label printer according to the embodiment is capable of stopping the printing operation and notifying of an error in the case where a disconnection has been detected from the heating element that has printed the image region requiring high print quality. Further, the label printer according to the embodiment is capable of notifying of an error without stopping the printing operation in the case where a disconnection has been detected from the heating element that has printed the image region requiring low print quality.

Further, in the above embodiment, the ROM 12 or the data memory 14 of the label printer 1 stores the program for the processor 11 to execute the above-mentioned processing or control. Programs that have been individually transferred may be written to the data memory 14 that is a writable storage device included in the label printer 1 in accordance with an operation by the administrator or the like. Further, the program may be stored in a non-temporary tangible computer-readable storage medium and transferred, or may be transferred through communication via a network. The non-temporary tangible computer-readable storage medium only needs to store program data and be readable by a device like optical discs, a memory cards, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a conveying motor configured to convey a print medium to a print position;
a thermal head having a plurality of heating elements arranged in a printing line orthogonal to a conveying direction of the print medium at the print position;
a head driving device configured to cause each of the heating elements to generate heat in accordance with image data for each printing line of a print image;
a check circuit configured to check for malfunctions for each of the heating elements; and
a processor configured to execute a malfunction check using the check circuit on a heating element that has been determined to need to be subjected to a malfunction check on a basis of a priority setting for each image region in the print image.

2. The image forming apparatus according to claim 1, wherein
the processor is further configured to execute the malfunction check using the check circuit in a period in which an unprinted region in the print image passes through the print position.

3. The image forming apparatus according to claim 1, wherein
the processor is further configured to execute, where print images of a plurality of pages are continuously printed, the malfunction check using the check circuit in a period from an end of printing a print image of a page to a start of printing a print image of a next page.

4. The image forming apparatus according to claim 1, wherein
the processor is further configured to execute, where the check circuit detects a malfunction of the heating element, error processing corresponding to a level of a priority setting of an image region corresponding to the heating element from which the malfunction has been detected.

5. The image forming apparatus according to claim 4, wherein
the processor is further configured to
stop a printing operation and notify of an error where the priority setting of the image region corresponding to the heating element from which the malfunction has been detected by the check circuit is high, and
notify of an error while continuing the printing operation where the priority setting of the image region corresponding to the heating element from which the malfunction has been detected by the check circuit is low.

6. The image forming apparatus according to claim 1, wherein
the priority setting is made for each image region in accordance with print quality required for each image region of the print image.

7. The image forming apparatus according to claim 1, wherein
the processor is further configured to acquire a print image and information indicating a priority setting relating to a disconnection check for each image region in the print image.

8. The image forming apparatus according to claim 1, wherein
the priority setting is made before execution of printing.

9. The image forming apparatus according to claim 1, wherein
the processor is further configured to identify the priority setting of each image region in the print image in accordance with a designated print format.

10. The image forming apparatus according to claim 1, wherein
the processor is further configured to set, on a basis of the priority setting of each image region in the print image, a heating element group on which a disconnection check for each image region is to be performed.
